(19) United States
(12) Patent Application Publication
(10) Pub. No.: US 2013/0103653 A1
(43) Pub. Date: Apr. 25, 2013

(54) SYSTEM AND METHOD FOR OPTIMIZING THE LOADING OF DATA SUBMISSIONS

(71) Applicant: Trans Union, LLC, Chicago, IL (US)

(72) Inventors: Jeffrey Carson, Oak Lawn, IL (US); Eric Haszlakiewicz, Chicago, IL (US); Stanley Parker, Lake Barrington, IL (US); Mark Wajda, Toronto (CA)

(73) Assignee: Trans Union, LLC, Chicago, IL (US)

(21) Appl. No.: 13/654,267

(22) Filed: Oct. 17, 2012

Related U.S. Application Data
(60) Provisional application No. 61/549,737, filed on Oct. 20, 2011.

(51) Int. Cl. G06F 7/00; G06F 17/30

(52) U.S. Cl. 707/690; 707/E17.005

(57) ABSTRACT

A system and method for detecting changes in data records based on summary values calculated on input data and existing data in a database is provided. An input data record including indicative data and financial data may be received. The indicative data may be normalized. A summary value may be calculated based on the normalized data to determine if any differences between the input record and existing data exist. If an existing summary value corresponding to the input record does not exist, the calculated summary value and financial data may be stored. If an existing summary value corresponding to the input record exists, the calculated summary value and the existing summary value may be compared to determine if they are equivalent. The calculated summary value and financial data may be stored if the summary values are not equivalent. The financial data may be stored if the summary values are equivalent.

### CROSS-REFERENCE TO RELATED APPLICATION

This application claims priority to U.S. Provisional Application No. 61/549,737, filed Oct. 20, 2011, which is incorporated herein by reference in its entirety.

### TECHNICAL FIELD

This invention relates to a system and method for optimizing the loading of data submissions into a database. More particularly, the invention provides a system and method for detecting changes in data records based on summary values calculated on input data submissions and on existing data in a database.

### BACKGROUND OF THE INVENTION

The consumer lending industry bases its decisions to grant credit or make loans, or to give consumers preferred credit or loan terms, on the general principle of risk, i.e., risk of foreclosure. Credit and lending institutions typically avoid granting credit or loans to high risk consumers, or may grant credit or lending to such consumers at higher interest rates or other terms less favorable than those typically granted to consumers with low risk. Consumer data, including consumer credit information, is collected and used by credit bureaus, financial institutions, and other entities for assessing creditworthiness and aspects of a consumer's financial and credit history.

New and updated consumer data may be loaded into a credit data database at a credit bureau on a nearly constant basis. The consumer data may include information such as indicative data to identify the consumer and financial data related to trade lines, e.g., lines of credit, such as the status of debt repayment, on-time payment records, etc. Computational resources must be devoted to processing the loading of consumer data, such as loading, searching, and matching the indicative data of an input load record with the indicative data in an existing data record to determine if any changes have occurred. Such processes can be computationally expensive and inefficient, and accordingly, reduce the overall data loading capacity of a system. This problem may be more pronounced in countries and markets with large populations and/or large numbers of data records. Such negative effects may even cause loading of data to fail to execute within necessary timeframes and specifications.

Therefore, there is a need for an improved system and method that can efficiently load and process consumer data records that are input into a database, in order to, among other things, increase data loading capacity and reduce the amount of resources devoted to loading a particular data record.

### SUMMARY OF THE INVENTION

The invention is intended to solve the above-noted problems by providing systems and methods for detecting changes in data records based on summary values calculated on input data submissions and on existing data in a database. The systems and methods are designed to, among other things: (1) normalize all or a portion of an input data record to standardize the data in preparation for comparison to existing data; (2) calculate a summary value on all or a portion of the input data record for comparison to an existing summary value; and (3) create or update a summary value record and/or a data record corresponding to the input data record, based on the comparison of the summary values.

In a particular embodiment, all or a portion of a received input data record containing consumer data may be selected and normalized. A summary value may be calculated on the normalized data, and may be a hash code, hash value, checksum, or cyclic redundancy check (CRC). The calculated summary value may be compared to an existing summary value to determine if changes have occurred to existing data in a database, as compared to data in the input data record. If there is no existing summary value, then a new data record and a new summary value record may be created in one or more databases. If the calculated summary value is not equivalent to the existing summary value, then the existing data record and the summary value record may be updated in the databases. If the calculated summary value is equivalent to the existing summary value, then no changes to the existing summary value occur. Loading of other data from the input data record may be performed, such as the loading of updates to trade lines to a credit data database or other database.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a system for detecting changes in data records based on summary values calculated on input data submissions and on existing data in a database.

FIG. 2 is a block diagram of one form of a computer or server of FIG. 1, having a memory element with a computer readable medium for implementing the system for detecting changes in data records based on summary values calculated on input data submissions and on existing data in a database.

FIG. 3 is a flowchart illustrating operations for detecting changes in data records based on summary values calculated on input data submissions and on existing data in a database using the system of FIG. 1.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

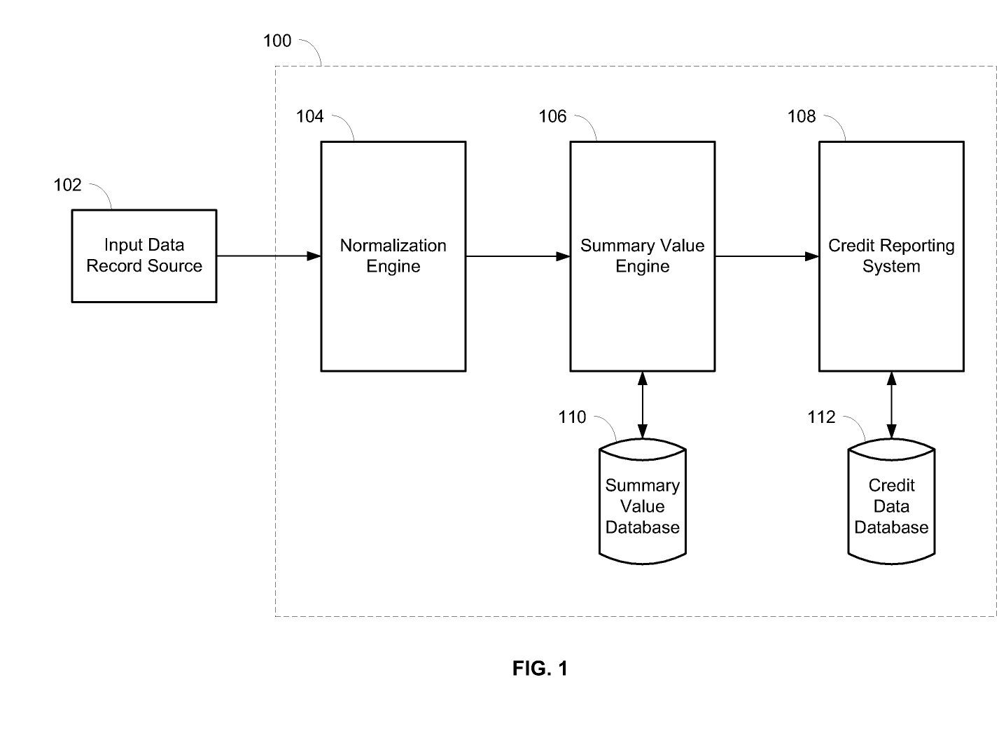

FIG. 1 illustrates a data loading system 100 for detecting changes in data records based on summary values calculated on input data submissions and on existing data in a database, in accordance with one or more principles of the invention. The system 100 may utilize data from an input data record that is intended to be loaded into a credit reporting system 108 and associated credit data database 112. The system 100 may be part of or include parts of a larger system, such as the International Credit Reporting System (iCRS) from TransUnion.

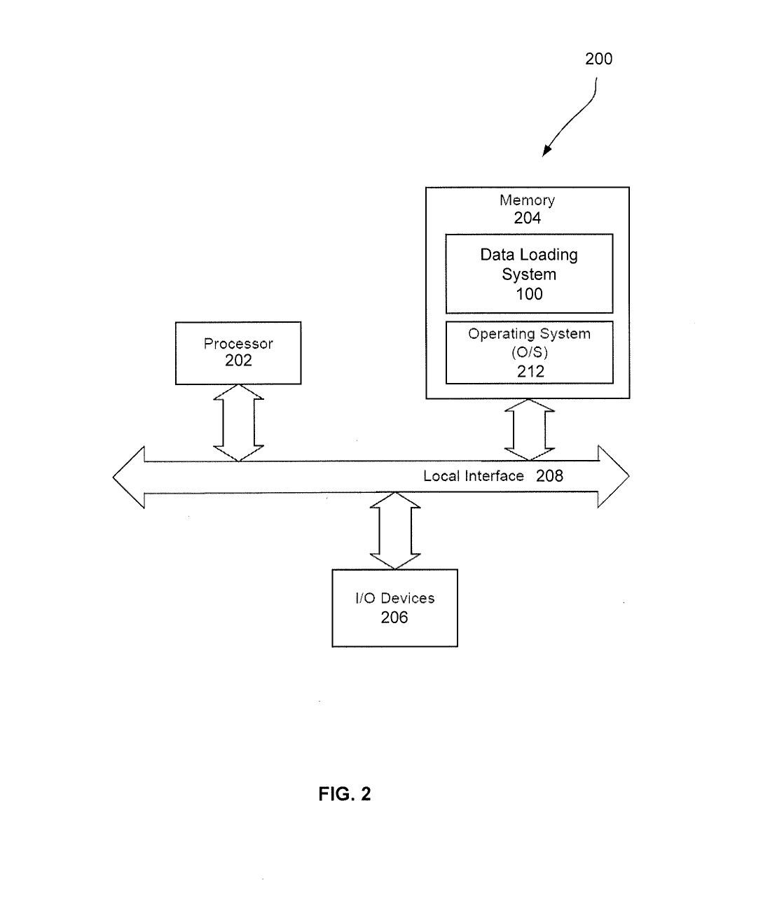

Various components of the system 100 may be implemented using software executable by one or more servers or computers, such as a computing device 200 with a processor 202 and memory 204 as shown in FIG. 2, which is described in more detail below. In one embodiment, the system 100 can normalize and calculate the summary value for all or a portion of an input data record submission using a normalization engine 104 and a summary value engine 106. In another embodiment, the system 100 can compare the calculated summary value with an existing summary value to determine whether there are changes in the input data record as compared to existing data in a credit data database 112. The existing summary value may be stored in a summary value database 110.

An input data record may be generated and transmitted from a source 102. The input data record may include credit information corresponding to a consumer, such as indicative data to identify the consumer as well as financial data related to trade lines, e.g., lines of credit, such as the status of debt repayment, on-time payment records, etc. The source 102 may be a member of a credit bureau, including financial institutions, insurance companies, utility companies, etc. that have credit information related to one or more consumers. The credit information may be based on credit that was granted to a consumer. For example, a bank may periodically send an input data record for a consumer that has a loan with the bank. The input data record may identify the consumer with indicative data, such as name, address, account number, date of birth, identification number, etc. The input data record may also contain data related to the status of the loan, such as an outstanding balance, date of last payment, on-time status, and other information. The input data record may be sent monthly, for example, or more or less often. The format of the input data record may be specific and different for particular markets and/or countries.

A normalization engine 104 can convert all or a portion of the data in the input data record received from the source 102 into a condensed normalized format to allow for fuzzier matching of data. Exact and pattern substitutions using regular expressions may be utilized in the normalization engine 104 to convert the data. In one embodiment, the indicative data in the input data record is normalized by the normalization engine 104 before being operated upon by a summary value engine 106 to calculate a summary value. For example, instances of the abbreviation “NY” may be replaced with “New York”. As another example, digits in an address may be spelled out, e.g., “1st Street” becomes “First Street”. As a further example, common abbreviations for names may be expanded, e.g., “Jr.” becomes “Junior”. Accordingly, the summary value calculated for the indicative data in the input data record may be equivalent to a previously-calculated summary value in the summary value database 110 for the same consumer, if the indicative data has not changed.

The summary value engine 106 can calculate a summary value for the normalized data received from the normalization engine 104. As described above, the normalized data may be a version of all or a portion of the data in the input data record. In some embodiments, one or more summary values may be calculated for different portions of the input data record. The summary value may be a hash code, hash value, checksum, cyclic redundancy check (CRC), or other unique representation of the data in the input data record. The summary value may be calculated using a deterministic function such as a hash function (e.g., MD5, SHA-2, etc.), a checksum function or algorithm, or a CRC algorithm (e.g., CRC-32). In the case where the summary value is a CRC value, the CRC value can be calculated off of the input data record by summing values of the characters in strings of the input data record and dividing the resulting sum by a prime number. The strings of the input data record may be the indicative data, for example.

Existing summary values may be looked up by the summary value engine 106 from a summary value database 110 that is in communication with the summary value engine 106. The summary value engine 106 may calculate a summary value based on the data in the input data record and subsequently compare the calculated summary value to an existing summary value in the summary value database 110 for the same consumer. An existing summary value, if any, may be retrieved from the summary value database 110 based on a lookup key. In one embodiment, a piece of data from the input data record may be used as the lookup key to find an existing summary value in the summary value database 110. The piece of data used as a lookup key may include an account number, member KOB (kind of business) and code, account type, ownership indicator, and/or contract type. The piece of data may also be combined with a piece of indicative data for the lookup key, such as in certain markets where account numbers may be duplicated. In another embodiment, the calculated summary value based on the input data record may be used as the lookup key against the summary value database 110. There is no distinction in this embodiment between a mismatch with an existing summary value and if there is no existing summary value because the calculated summary value would not find a match in cases when the input data record differs from existing data.

If the summary value engine 106 does not find an existing summary value in the summary value database 110, then the input data record may be considered new. A new summary value record containing the calculated summary value may be created in the summary value database 110 corresponding to the consumer. This summary value record may have a lookup key associated with it, as described above, or may include only the calculated summary value. In addition, a new data record based on the input data record may be created in the credit data database 112 by a credit reporting system 108. The credit reporting system 108 may manage, process, and analyze credit information that is stored in the credit data database 112. Members of the credit bureau may access and query the credit reporting system 108 to retrieve credit data related to a consumer. For example, a search query may be initiated by a bank when a consumer applies for a loan so that the bank can examine the consumer's credit report to assess the creditworthiness of the consumer. The bank can input the consumer's personal information in the search query to the credit reporting system 108 in order to retrieve the credit report.

The summary value engine 106 may also retrieve an existing summary value from the summary value database 110 that corresponds to the consumer. In this case, the calculated summary value and the existing summary value may be compared to determine if they are equivalent. If the calculated summary value and the existing summary value are not equivalent, this indicates that a change in the consumer's data record for which the summary value applies (e.g., indicative data) has occurred. In this case, the calculated summary value may replace the existing summary value in the summary value database 110. In addition, the consumer's data record may be retrieved from the credit data database 112 and compared to the input data record to determine what changes have occurred. The changes in the data may be updated in the credit data database 112, based on the input data record. Updates to information from the input data record for which the summary value does not apply (e.g., trade lines) may also be changed in the consumer's data record in the credit data database 112.

However, if the calculated summary value and the existing summary value are equivalent, this indicates that there has been no change in the consumer's data record for which the summary value applies (e.g., indicative data). The summary value database 110 does not need to be updated in this case. Moreover, the consumer's data record does not need to be updated in the credit data database 112 for information for which the summary value applies. Updates to information from the input data record for which the summary value does not apply (e.g., trade lines) may also be changed in the consumer's data record in the credit data database 112.

FIG. 2 is a block diagram of a computing device 200 housing executable software used to facilitate the data loading system 100. One or more instances of the computing device 200 may be utilized to implement any, some, or all of the components in the system 100, including the normalization engine 104, the summary value engine 106, and the credit reporting system 108. Computing device 200 includes a memory element 204. Memory element 204 may include a computer readable medium for implementing the system 100, and for implementing particular system transactions. Memory element 204 may also be utilized to implement the summary value database 110 and the credit data database 112. Computing device 200 also contains executable software, some of which may or may not be unique to the system 100.

In some embodiments, the system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 200 may be representative of any computer in which the system 100 resides or partially resides.

Generally, in terms of hardware architecture as shown in FIG. 2, computing device 200 includes a processor 202, a memory 204, and one or more input and/or output (I/O) devices 206 (or peripherals) that are communicatively coupled via a local interface 208. Local interface 208 may be one or more buses or other wired or wireless connections, as is known in the art. Local interface 208 may have additional elements, which are omitted for simplicity, such as controllers, buffers (caches), drivers, transmitters, and receivers to facilitate external communications with other like or dissimilar computing devices. Further, local interface 208 may include address, control, and/or data connections to enable internal communications among the other computer components.

Processor 202 is a hardware device for executing software, particularly software stored in memory 204. Processor 202 can be any custom made or commercially available processor, such as, for example, a Core series or vPro processor made by Intel Corporation, or a Phenom, Athlon or Sempron processor made by Advanced Micro Devices, Inc. In the case where computing device 200 is a server, the processor may be, for example, a Xeon or Itanium processor from Intel, or an Opteron-series processor from Advanced Micro Devices, Inc. Processor 202 may also represent multiple parallel or distributed processors working in unison.

Memory 204 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 204 can have a distributed architecture where various components are situated remote from one another, but are still accessed by processor 202. These other components may reside on devices located elsewhere on a network or in a cloud arrangement.

The software in memory 204 may include one or more separate programs. The separate programs comprise ordered listings of executable instructions for implementing logical functions. In the example of FIG. 2, the software in memory 204 may include the system 100 in accordance with the invention, and a suitable operating system (O/S) 212. Examples of suitable commercially available operating systems 212 are Windows operating systems available from Microsoft Corporation, Mac OS X available from Apple Computer, Inc., a Unix operating system from AT&T, or a Unix-derivative such as BSD or Linux. The operating system O/S 212 will depend on the type of computing device 200. For example, if the computing device 200 is a PDA or handheld computer, the operating system 212 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 212 essentially controls the execution of other computer programs, such as the system 100, and provides scheduling, input-output control, file and data management, memory management, and communication control and related services.

If computing device 200 is an IBM PC compatible computer or the like, the software in memory 204 may further include a basic input output system (BIOS). The BIOS is a set of essential software routines that initialize and test hardware at startup, start operating system 212, and support the transfer of data among the hardware devices. The BIOS is stored in ROM so that the BIOS can be executed when computing device 200 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components of the system 100 may also be written in a proprietary language developed to interact with these known languages.

I/O device 206 may include input devices such as a keyboard, a mouse, a scanner, a microphone, a touch screen, a bar code reader, or an infra-red reader. It may also include output devices such as a printer, a video display, an audio speaker or headphone port or a projector. I/O device 206 may also comprise devices that communicate with inputs or outputs, such as a short-range transceiver (RFID, Bluetooth, etc.), a telephonic interface, a cellular communication port, a router, or other types of network communication equipment. I/O device 206 may be internal to computing device 200, or may be external and connected wirelessly or via connection cable, such as through a universal serial bus port.

When computing device 200 is in operation, processor 202 is configured to execute software stored within memory 204, to communicate data to and from memory 204, and to generally control operations of computing device 200 pursuant to the software. The system 100 and operating system 212, in whole or in part, may be read by processor 202, buffered within processor 202, and then executed.

In the context of this document, a “computer-readable medium” may be any means that can store, communicate, propagate, or transport data objects for use by or in connection with the system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system 100 can be embodied in any type of computer-readable medium for use by or in connection with an instruction execution system or apparatus, such as a computer.

For purposes of connecting to other computing devices, computing device 200 is equipped with network communication equipment and circuitry. In a preferred embodiment, the network communication equipment includes a network card such as an Ethernet card, or a wireless connection card. In a preferred network environment, each of the plurality of computing devices 200 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 200 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

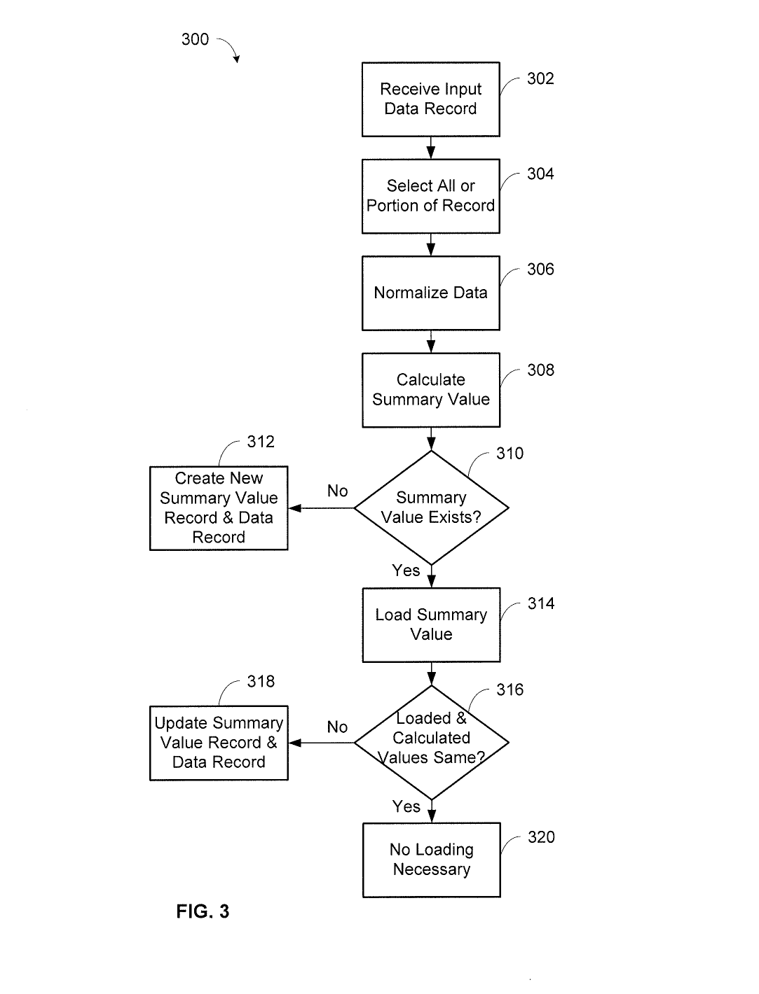

An embodiment of a process 300 for detecting changes in data records based on summary values calculated on input data submissions and on existing data in a database is shown in FIG. 3. The process 300 can result in the creation or update of credit data records in a credit data database 112 if a change in the credit data records has been detected through the calculation and comparison of summary values. The credit data database 112 may include records for consumers including indicative data to identify the consumer as well as data related to trade lines, e.g., lines of credit, such as the status of debt repayment, on-time payment records, etc. The summary value database 110 may include records of summary values that correspond to records in the credit data database 112, and in particular, summary values that are representations of data in those records. In one embodiment, the summary values are representations of the indicative data in the records. However, the summary values could be representations of any of the data in the records in the credit data database 112. The normalization engine 104, summary value engine 106 and/or the credit reporting system 108 may perform all or part of the process 300.

At step 302, one or more input data records may be received at the data loading system 100 from a source 102. The input data record may include credit information corresponding to a consumer, such as indicative data to identify the consumer as well as data related to trade lines, e.g., lines of credit, such as the status of debt repayment, on-time payment records, etc. The source 102 may be a member of a credit bureau, including financial institutions, insurance companies, utility companies, etc. that has credit information related to one or more consumers. All or a portion of the input data record may be selected at step 304 for a calculation of a summary value. In one embodiment, the indicative data in the input data record may be selected at step 304. The input data record may be sent from the source 102 on a monthly basis, for example, or more or less often.

The selected data from step 304 maybe normalized at step 306 by the normalization engine 104. The normalization engine 104 can convert the selected data from the input data record into a condensed normalized format to allow for fuzzier matching of data. A summary value may be calculated on the normalized data at step 308 by the summary value engine 106. The summary value engine 106 can calculate a summary value for the normalized data received from the normalization engine 104. In some embodiments, one or more summary values may be calculated for different portions of the input data record. The summary value may be a hash code, hash value, checksum, cyclic redundancy check (CRC), or other unique representation of the data in the input data record, as described above.

After the summary value is calculated, it can be determined at step 310 whether a summary value already exists in the summary value database 110 that corresponds to the consumer associated with the input data record. The summary value engine 106 may attempt to retrieve an existing summary value from the summary value database 110 using a lookup key, such as another piece of information from the input data record (e.g., an account number) or the calculated summary value. If there is not an existing summary value in the summary value database 110 at step 310, then the input data record may be classified as new and the process 300 continues to step 312. At step 312, a new summary value record may be created in the summary value database 110 that contains the calculated summary value from step 308. In addition, the information in the input data record may be loaded into a new data record in the credit data database 112. The process 300 may be complete after the execution of step 312.

However, if there is an existing summary value in the summary value database 110 at step 310, then the process 300 continues to step 314. At step 314, the existing summary value is loaded from the summary value database 110. An existing summary value will be present if there is a corresponding data record in the credit data database 112. In some embodiments, the data record in the credit data database 112 may be further confirmed to match the input data record by successfully comparing the account number in the input data record with the account number in the existing data record. The calculated summary value and the loaded existing summary value may be compared to determine if they are equivalent at step 316. The calculated summary value and the existing summary value may be determined to be equivalent if they exactly match one another. If the calculated summary value and the existing summary value are equivalent, then at step 320, no loading of the input data record is necessary and the process 300 is complete. Although the summary values are equivalent, indicating that the data corresponding to the summary values (e.g., indicative data) has not changed, other data in the input data record may be updated to the data record in the credit data database 112 at step 320. This other data may include, for example, financial data related to trade lines.

Returning to step 316, if the calculated summary value and the existing summary value are not equivalent, then the input data record may be classified as needing an update and the process 300 continues to step 318. The non-equivalence of the summary values indicates that the data corresponding to the summary values (e.g., indicative data) has changed. At step 318, the calculated summary value may replace the existing summary value in the summary value database 110. The data record in the credit data database 112 may also be retrieved, compared, and updated to reflect the changes in the data from the input data record. In addition, the financial data (e.g., trade lines) in the input data record that does not correspond to the summary value may also be updated in the data record in the credit data database 112 at step 318.

When records in the summary value database 110 and the credit data database 112 are created or updated, a last modified date may be updated in the applicable database with the current date. In some embodiments, the summary value for a corresponding data record may be stored with the data record in the credit data database 112. Changes in information, such as indicative data, may be transmitted in an inquiry from a member of the credit bureau to the credit reporting system 108 and credit data database 112. If such a change in information is detected in an inquiry, this new data may be stored with the data record in the credit data database 112. In addition, the summary value attached to that data record may be removed. In this case, when an input data record is received by the data loading system 100 for loading at a future time, such as through the process 300, the system 100 may detect the absence of the summary value in the corresponding data record in the credit data database 112 and update the appropriate records as needed.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method for detecting changes in a data record stored in a database using a processor, the method comprising:
receiving an input data record associated with a consumer at the processor, the input data record comprising indicative data and financial data;
normalizing at least a portion of the indicative data to produce normalized indicative data, using the processor;
calculating a summary value based on the normalized indicative data, using the processor, wherein the summary value is a representation of the indicative data;
determining whether an existing summary value associated with the consumer exists in the database by using a lookup key related to the input data record, using the processor;
if the existing summary value is not present in the database, creating in the database a new data record associated with the consumer, the new data record comprising the summary value, the indicative data, and the financial data, using the processor; and
if the existing summary value is present in the database:
loading the existing summary value from an existing data record associated with the consumer from the database, using the processor;
determining if the summary value and the existing summary value are equivalent, using the processor;
if the summary value and the existing summary value are not equivalent:
replacing the existing summary value with the summary value in the existing data record in the database, using the processor; and
storing the indicative data and the financial data in the existing data record in the database, using the processor; and
storing the financial data in the existing data record in the existing data record in the database, using the processor, if the summary value and the existing summary value are equivalent.

2. The method of claim 1, wherein:
the summary value comprises one or more of a hash code, a hash value, a checksum, or a cyclic redundancy check (CRC); and
calculating the summary value comprises calculating the summary value by applying a deterministic function on the normalized indicative data, using the processor.

3. The method of claim 2, wherein the deterministic function comprises one or more of a hash function, a checksum function, a checksum algorithm, or a CRC algorithm.

4. The method of claim 1, wherein the lookup key comprises one or more of a piece of data of the indicative data, a piece of data of the financial data, or the summary value.

5. The method of claim 4, wherein the piece of data of the financial data comprises one or more of an account number, a member kind of business, a member code, an account type, an ownership indicator, or a contract type.

6. The method of claim 1, further comprising if the existing summary value is not present in the database, storing the lookup key in the new data record associated with the consumer, using the processor.

7. The method of claim 1, wherein storing the indicative data and the financial data in the database, if the summary value and the existing summary value are not equivalent comprises:
retrieving the indicative data and the financial data from the existing data record, using the processor;
determining a difference between one or more of the indicative data or the financial data from the input data record and one or more of the retrieved indicative data or the retrieved financial data, using the processor; and
updating the existing data record based on the determined difference, using the processor.

8. The method of claim 1, wherein storing the financial data in the database, if the summary value and the existing summary value are equivalent comprises:
retrieving the financial data from the existing data record, using the processor;
determining a difference between the financial data from the input data record and the retrieved financial data, using the processor; and
updating the existing data record based on the determined difference, using the processor.

9. The method of claim 1, wherein normalizing the at least the portion of the indicative data comprises evaluating a regular expression to convert the at least the portion of the indicative data to the normalized indicative data, using the processor.

10. The method of claim 1, wherein:
the indicative data comprises data for identifying the consumer; and
the financial data comprises data related to a trade line associated with the consumer.

11. A system for detecting changes in a data record stored in a database, the system comprising:
a processor in communication with a network;
a memory in communication with the processor, the memory for storing:
the database;
a normalization engine for:
receiving an input data record associated with a consumer, the input data record comprising indicative data and financial data; and
normalizing at least a portion of the indicative data to produce normalized indicative data; and
a summary value engine for:
calculating a summary value based on the normalized indicative data, wherein the summary value is a representation of the indicative data;
determining whether an existing summary value associated with the consumer exists in the database by using a lookup key related to the input data record;
if the existing summary value is not present in the database, creating a new data record associated with the consumer in the database, the new data record comprising the summary value, the indicative data, and the financial data; and
if the existing summary value is present in the database:
loading the existing summary value from an existing data record associated with the consumer from the database;
determining if the summary value and the existing summary value are equivalent;
if the summary value and the existing summary value are not equivalent:
replacing the existing summary value with the summary value in the existing data record in the database; and
storing the indicative data and the financial data in the existing data record in the database; and
storing the financial data in the existing data record in the existing data record in the database, if the summary value and the existing summary value are equivalent.

12. The system of claim 11, wherein:
the summary value comprises one or more of a hash code, a hash value, a checksum, or a cyclic redundancy check (CRC); and
the summary value engine calculates the summary value by calculating the summary value by applying a deterministic function on the normalized indicative data.

13. The system of claim 12, wherein the deterministic function comprises one or more of a hash function, a checksum function, a checksum algorithm, or a CRC algorithm.

14. The system of claim 11, wherein the lookup key comprises one or more of a piece of data of the indicative data, a piece of data of the financial data, or the summary value.

15. The system of claim 14, wherein the piece of data of the financial data comprises one or more of an account number, a member kind of business, a member code, an account type, an ownership indicator, or a contract type.

16. The system of claim 11, wherein the summary value engine is further for if the existing summary value is not present in the database, storing the lookup key in the new data record associated with the consumer.

17. The system of claim 11, wherein the summary value engine stores the indicative data and the financial data in the database, if the summary value and the existing summary value are not equivalent by:
retrieving the indicative data and the financial data from the existing data record;
determining a difference between one or more of the indicative data or the financial data from the input data record and one or more of the retrieved indicative data or the retrieved financial data; and
updating the existing data record based on the determined difference.

18. The system of claim 11, wherein the summary value engine stores the financial data in the database, if the summary value and the existing summary value are equivalent by:
retrieving the financial data from the existing data record;
determining a difference between the financial data from the input data record and the retrieved financial data; and
updating the existing data record based on the determined difference.

19. The system of claim 11, wherein the normalization engine normalizes the at least the portion of the indicative data by evaluating a regular expression to convert the at least the portion of the indicative data to the normalized indicative data.

20. The system of claim 11, wherein:
the indicative data comprises data for identifying the consumer; and
the financial data comprises data related to a trade line associated with the consumer.
